(19) United States
(12) Patent Application Publication
(10) Pub. No.: US 2015/0159696 A1
(43) Pub. Date: Jun. 11, 2015

(54) BEARING COMPONENT

(71) Applicant: AKTIEBOLAGET SKF, Göteborg (SE)

(72) Inventors: Nils Manne, Goteborg (SE); Mikael Sundqvist, Goteborg (SE); Christophe Baillie, Genas (FR)

(21) Appl. No.: 14/378,382

(22) PCT Filed: Feb. 6, 2013
(86) PCT No.: PCT/SE2013/000018

§ 371 Date: Aug. 13, 2014

(30) Foreign Application Priority Data
Feb. 14, 2012 (SE) 1200092-3

(51) Int. Cl. F16C 33/46; B23P 15/00

(52) U.S. Cl. CPC F16C 33/4664; F16C 33/46; B23P 15/003

(57) ABSTRACT

A bearing component comprising a first cage cup formed from at least one first element configured to receive rolling elements. The bearing component further comprises a first flange formed from at least one second element and connected to a periphery of the first cage cup.

### CROSS REFERENCE TO RELATED APPLICATION

This is a National Stage application claiming the benefit of International Application Number PCT/SE2013/000018 filed on 6 Feb. 2013 (06.02.2013), which claims the benefit of Sweden Patent Application 1200092-3 filed on 14 Feb. 2012 (14.02.2012), both of which are incorporated herein by reference in their entireties.

### TECHNICAL FIELD

Embodiments herein relate generally to a bearing component, a method of manufacturing the bearing component, and a bearing comprising the bearing component. More particularly the embodiments herein relate to a flange connected to a cage cup.

### BACKGROUND

A bearing may be defined as a device to allow constrained relative motion between two or more parts, typically a rotation or a linear movement. There are several types of bearings, such as e.g. a roller bearing and a ball bearing. A bearing comprises different components, such as an inner ring and an outer ring, rolling elements and a cage for retaining the rolling elements. The inner and outer rings comprise raceways on which the rolling elements roll. The rolling element may be for example a ball, a cylindrical roller, a needle roller, a tapered roller, a spherical roller, a toroidal roller etc. The rolling elements are located in the cage. The cage keeps the rolling elements at an appropriate distance from each other, it keeps the rolling elements evenly distributed around the circumference, it guides the rolling elements in the unloaded zone and it retains the rolling elements.

Cages may have different design and are made of different materials depending on the purpose of the bearing. A cage may be made from an element such as a metal strip and formed as a ring. The cage may be provided with a plurality of pockets evenly distributed around the circumference of the ring for receiving the rolling elements. One peripheral side edge of the ring may be bent outwardly or inwardly so as to define a lip or a flange. Bending of the ring requires use of complicated and expensive drawing tools. The size of the metal strip requires a substantially large amount of material, since the metal strip needs to be big enough so that the peripheral edge can be bent. When bending the metal strip, there is a risk of applying a too large force so that the metal strip breaks. Another way of manufacturing a bearing cage is to draw and drill a cage out from a massive piece of material, which leads to large amounts of scrap, i.e. not very cost effective.

### SUMMARY

An object of embodiments herein is therefore to obviate at least one of the above disadvantages and to provide an improved bearing component.

According to a first aspect, the object is achieved by a bearing component comprising a first cage cup formed from at least one first element configured to receive rolling elements. The bearing component further comprises a first flange which is formed from at least one second element and connected to a periphery of the first cage cup.

According to a second aspect, the object is achieved by a bearing comprising the bearing component.

According to a third aspect, the object is achieved by a method for manufacturing a bearing component. A first cage cup is formed from at least one first element configured to receive rolling elements. A first flange is formed from at least one second element. Then, the first flange is connected to a periphery of the first cage cup.

Since the first flange is a separate component connected to the first cage cup, an improved bearing component is provided.

Embodiments herein afford many advantages, of which a non-exhaustive list of examples follows:

Since the bearing component is comprised of two parts, the first cage cup and the first flange which are connected together, the embodiments herein provides an advantage when it comes to manufacturing. Connecting the two parts together can be done without any need of expensive tools. Thus, lowering the manufacturing costs. Since no expensive tools are necessary for manufacturing the bearing component, another advantage is that more tailored bearing components can be made without a high cost.

Another advantage is that the bearing component requires less material compared to known bearing components.

A further advantage is that by connecting the first flange to the first cage cup the bearing component has a very good stiffness, which makes the bearing component stable and robust.

Furthermore, since the first flange is a separate component connected to the first cage cup it provides an advantage of freedom in the design of the bearing component. For example, the first flange may have a different thickness than the first cage cup, it can be made of a different material than the first cage cup, it can have a different surface than the first cage cup etc.

The embodiments herein are not limited to the features and advantages mentioned above. A person skilled in the art will recognize additional features and advantages upon reading the following detailed description.

### BRIEF DESCRIPTION OF THE DRAWINGS

The embodiments herein will now be further described in more detail in the following detailed description by reference to the appended drawings illustrating the embodiments and in which:

FIG. 1a-b are schematic drawings illustrating an embodiment of the cage cup, the flange and the bearing component.

FIG. 2a-c are schematic drawings illustrating an embodiment of the bearing component.

FIG. 3 is a schematic drawing illustrating an embodiment of the bearing.

FIG. 4 is a schematic drawing illustrating an embodiment of the bearing component.

FIG. 5 is a schematic drawing illustrating an embodiment of the bearing component.

FIG. 6 is a schematic drawing illustrating an embodiment of the bearing component comprising two flanges.

FIG. 7 is a schematic drawing illustrating an embodiment of the bearing component comprising a guide ring.

FIG. 8 is a schematic drawing illustrating an embodiment of the bearing component comprising a laminated cage cup.

FIG. 9 is a schematic drawing illustrating an embodiment of the bearing component comprising two spaced apart cage cups.

FIG. 10a-b are schematic drawings illustrating an embodiment of the bearing component comprising two cage cups.

FIG. 11a-d are schematic drawings illustrating embodiments of the bearing component.

FIG. 12 is a flow chart illustrating embodiments of a method for manufacturing the bearing component.

The drawings are not necessarily to scale and the dimensions of certain features may have been exaggerated for the sake of clarity. Emphasis is instead placed upon illustrating the principle of the embodiments herein.

### DETAILED DESCRIPTION

The embodiments herein relates to a bearing component comprising a flange connected to a cage cup.

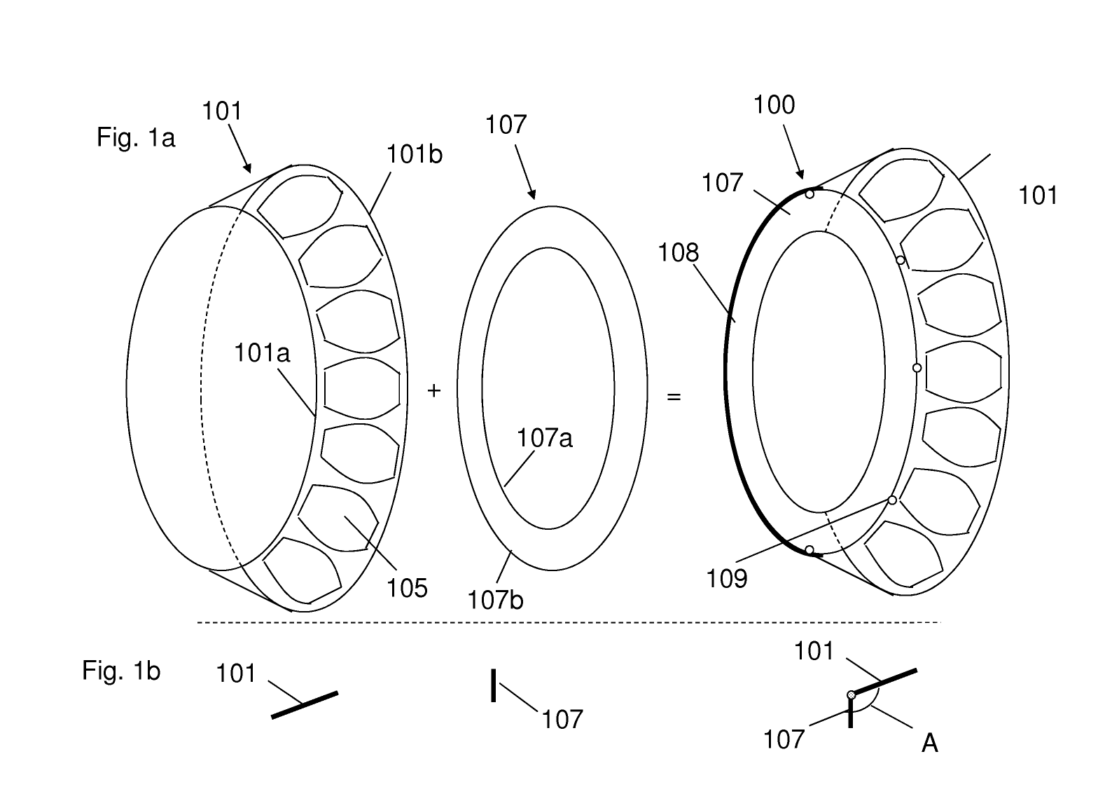

FIG. 1a illustrates an embodiment of the bearing component 100. The bearing component 100 comprises a first cage cup 101. The first cage cup 101 is made of at least one first element. The first element may be in the form of a strip or a string, and it may be formed as e.g. a ring by connecting the ends of the strip together using any suitable connecting means. The first element may be made of a polymer or a metal such as for example stainless steel, copper, brass or iron. The first cage cup 101 may have for example a tapered form or a cylindrical form. A tapered form is used in the following as an example and the first cage cup 101 is referred to as having a tapered surface. The periphery of the first cage cup 101 has a first side edge 101a and a second side edge 101b. When using the tapered example, the first side edge 101a has a diameter which is smaller than the diameter of the second edge 101b.

The first cage cup 101 may comprise a plurality of spaced apart pockets 105 which are configured to receive rolling elements (not shown). The pockets 105 may be evenly or unevenly distributed around the circumference of the first cage cup 101. The pockets 105 may be premade, or made in a later state. The size of the pockets 105 are depending on the size of the rolling elements. The rolling elements may be for example a ball, a cylindrical roller, a needle roller, a tapered roller, a spherical roller, a toroidal roller etc.

The bearing component 100 further comprises a first flange 107. The first flange 107 is formed from at least a second element. In one embodiment, the first flange 107 is made from one continuous second element. In another embodiment, the first flange 107 is made from a plurality of elements. The second element may be in the form of a strip or a string, and it may be formed as a ring or a circular disk. The circular disc may be flat. The flat circular disc is used as an example in the following. The second element may be made of a polymer or a metal such as for example stainless steel, copper, brass or iron. The flat circular disk has a third side edge 107a and a fourth side edge 107b. The diameter of the third side edge 107a is smaller than the diameter of the fourth side edge 107b.

The first flange 107 is connected to periphery of the first cage cup 101, as seen to the right in FIG. 1. When using the tapered example, the first flange 107 is connected at its fourth side edge 107b to the first side edge 101a at the periphery of the first cage cup 101. Thus, the diameter of the fourth side edge 107b corresponds to the diameter of the first side edge 101a.

The first flange 107 is connected to the periphery of the first cage cup 101 using different types of suitable connecting techniques. In one embodiment, the first flange 107 is welded to the first cage cup 101. The welding may be continuous 108, as illustrated with the thick line in the bearing component 100 in FIG. 1, or the welding may be dot welding 109, illustrated with small circles in the bearing component 100 in FIG. 1. In another embodiment, the first flange 107 is screwed to the first cage cup 101. The first flange 107 may also be glued to the first cage cup 101. In some embodiments, the first flange 107 may be connected to the first cage cup 101 using clips such as snap fit clips.

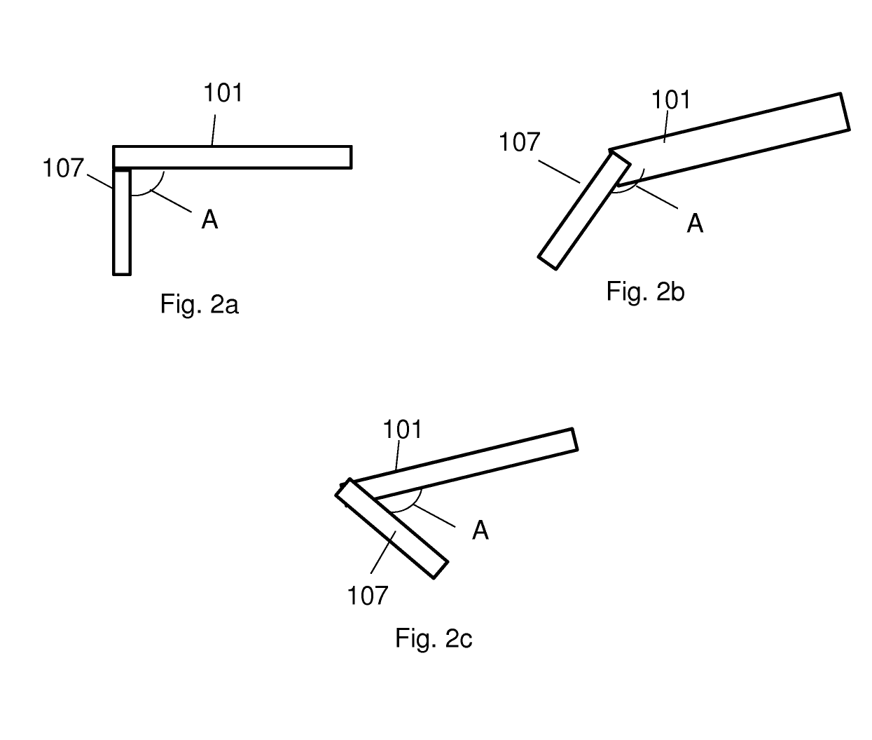

In FIG. 1b, below the dotted horizontal line, profiles of the first cage cup 101, the first flange 107 and the bearing component 100 are exemplified. The left most profile represents the profile of the first cage cup 101 and is exemplified with an inclined profile. The middle profile represents the profile of the first flange 107 and is exemplified with a vertical profile. The right profile represents the profile of the bearing component 100, i.e. when the first flange 107 is connected to the first cage cup 101. As seen from the right profile, there is an angle A between the plane of the first flange 107 and the first cage cup 101, i.e. the tapered surface. The angle A may be of different values. Some examples of the angle A are illustrated in FIG. 2a-c. In FIG. 2a, the angle A between the first flange 107 and the first cage cup 101 is approximately 90 Ë. In FIG. 2b, the angle A between the first flange 107 and the first cage cup 101 is approximately 60 Ë. In FIG. 2c, the angle A between the first flange 107 and the first cage cup 101 is approximately 30 Ë. In some embodiments, the first cage cup 101 has the same thickness as the first flange 107, as exemplified in FIG. 2a. In some embodiments, the first cage cup 101 has a different thickness than the first flange 107, as exemplified in FIG. 2b. For example, the first cage cup 101 may be thicker than the first flange 107 if the cage cup 101 needs to be stronger than the first flange 107. It gives a freedom when it comes to the design depending on which bearing the bearing component 100 is to be comprised in. Furthermore, different applications of the bearing may also influence the design of the bearing component 100, e.g. different load conditions, temperature, rotational velocity etc.

The first flange 107 and the first cage cup 101 may be made of the same material, or they may be made of different materials. Examples of materials are a polymer or a metal, for example stainless steel, copper, brass or iron.

The diameter of the first cage cup 101 may be within a range from a few centimetres up to several meters. For example, the diameter of the first cage cup 101 may be equal to greater than 0.5 m.

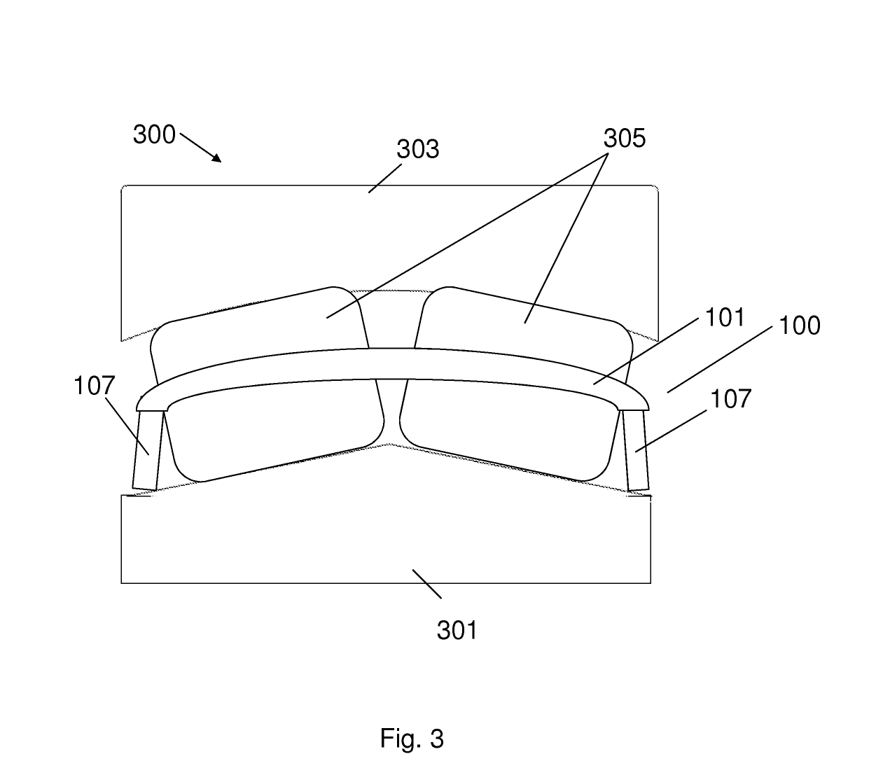

FIG. 3 illustrates a cross section of an example bearing 300. The bearing 300 may be for example a ball bearing or a rolling bearing, a spherical roller bearing, a tapered roller bearing or a cylindrical roller bearing. The bearing 300 comprises an inner ring 301 and an outer ring 303. The bearing 300 comprises rolling elements 305 positioned between the inner ring 301 and the outer ring 303. The first cage cup 101 is positioned so that the rolling elements 305 can be located in the pockets 105 (not shown in FIG. 3). The first flange 107 is connected to the periphery of the first cage cup 101. As seen from FIG. 3, the first flange 107 may prevent the rolling elements 305 from falling out of the bearing 300. The first flange 107 may also function as a guidance of the cage 100 to the inner ring 301.

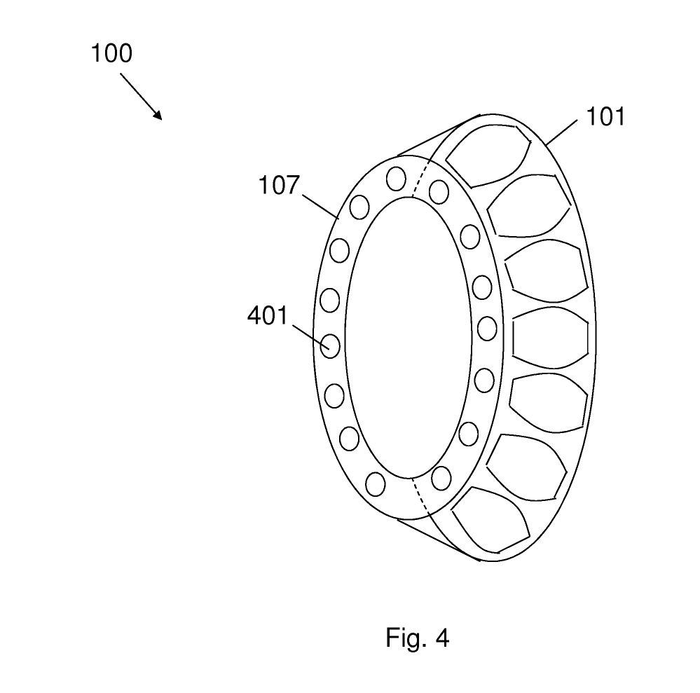

FIG. 4 illustrates an embodiment of the bearing component 100 where the first flange 107 comprises a plurality of windows 401. The windows 401 may be distributed evenly around the first flange 107 and they may be of any suitable size. When the first flange 107 comprises windows 401, less material is necessary to manufacture the first flange 107 and the whole bearing component 100 thereby has a low weight. In some embodiments, the windows 401 may have a size so that they are configured to receive rolling elements 305. In that case, the first flange 107 may be seen as a second cage cup.

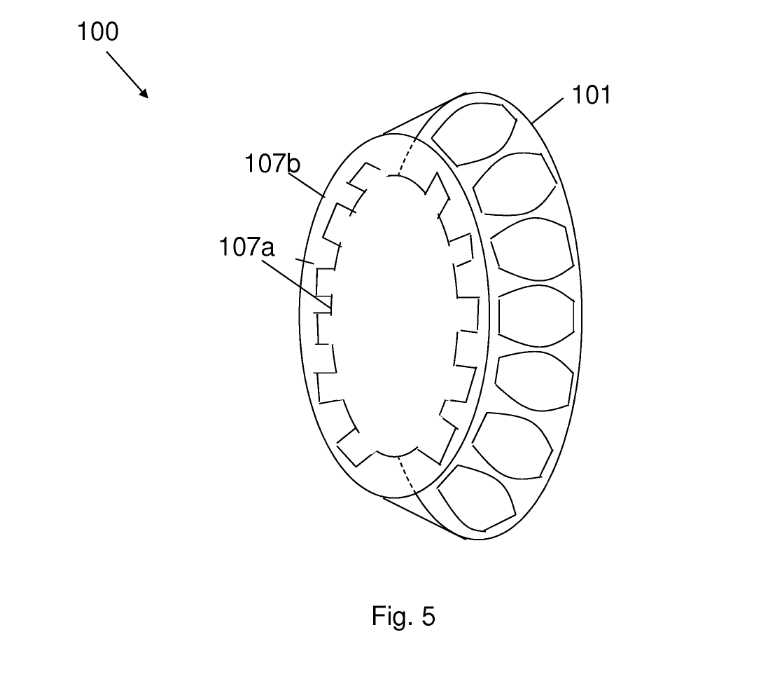

FIG. 5 illustrates another embodiment of the bearing component 100. In this embodiment, the third side edge 107a is toothed. The toothed third side edge 107a requires a smaller amount of material in the manufacturing of the first flange 107, and the whole bearing component 100 thereby has a lower weight compared to a continuous first flange 107. In some embodiments, each tooth is comprised of one element, and in another embodiment, the first flange 107 is made from only one element, e.g. a metal strip, where the teeth are for example cut out by using a laser.

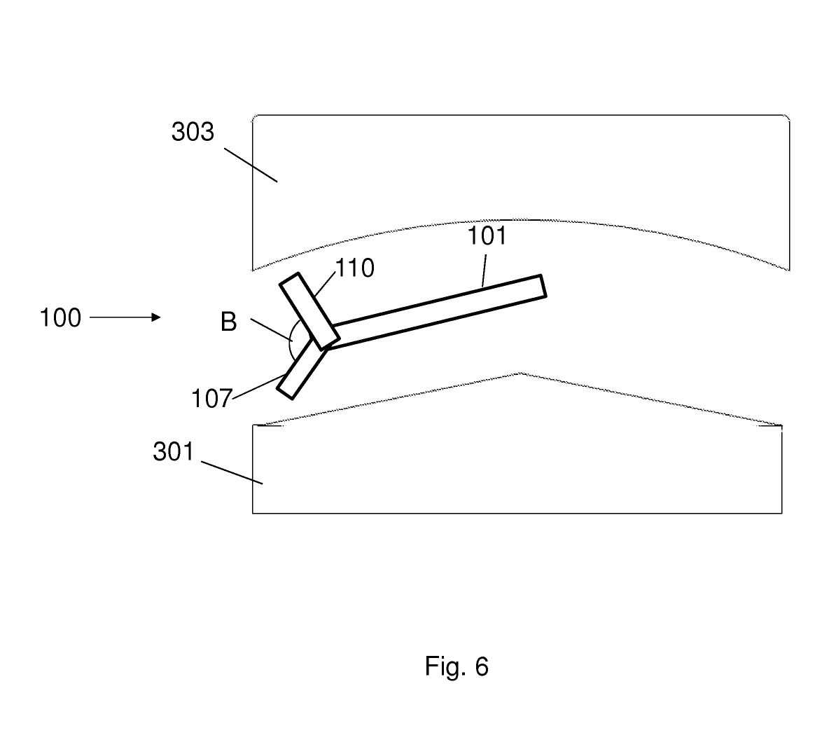

FIG. 6 illustrates another embodiment of the bearing component 100. The bearing component 100 is seen when it is located in the bearing 100. Only the inner ring 301 and the outer ring 303 are shown for the sake of simplicity. The bearing component 100 in this embodiment comprises the first flange 107 and a second flange 110. The second flange 110 is formed from at least one third element. In some embodiments, the second flange 110 is formed from a plurality of third elements, i.e. the second flange 110 comprises several segments connected together. The third element may be in the form of a strip or a string. The third element may be made of a polymer or a metal such as for example stainless steel, copper, brass or iron. The second flange 110 is connected to the periphery of the first cage cup 101, i.e. to the first side edge 101a. The first flange 107 and the second flange 110 are connected together at the first side edge at the periphery of the first cage cup 101 so as to extend in different directions. The angle B between the first flange 107 and the second flange 110 may have any suitable value. When the bearing component 100 comprises two flanges, the first flange 107 and the second flange 110, the bearing component 100 has a sealing function.

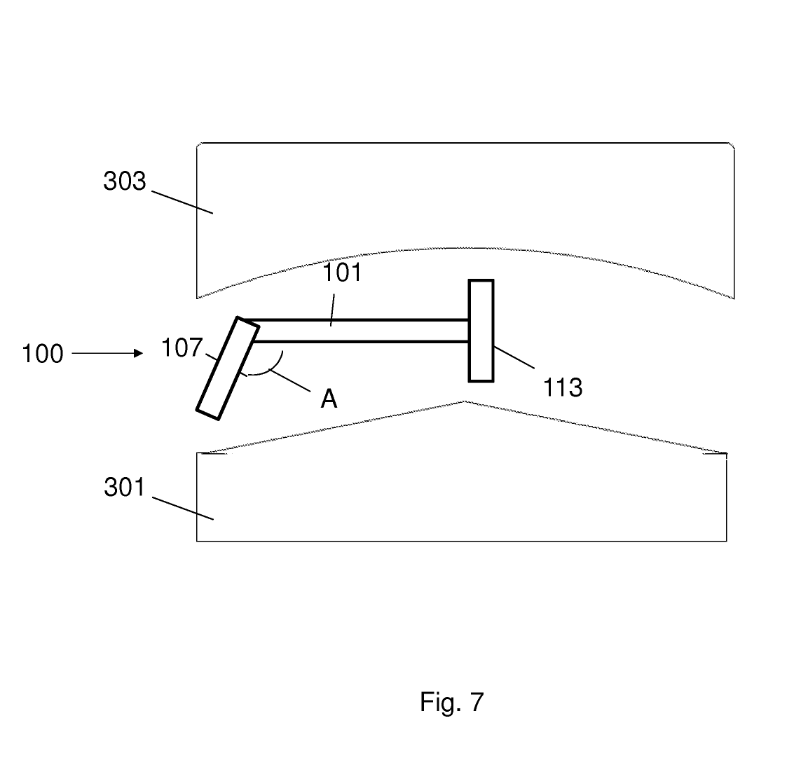

FIG. 7 illustrates an embodiment of the bearing component 100 comprising a guide ring 113. The guide ring 113 is formed from at least one fourth element. The third element may be in the form of a strip or a string. The third element may be made of a polymer or a metal such as for example stainless steel, copper, brass or iron. The guide ring 113 is connected to the periphery of the first cage cup 101, i.e. at the second side edge 101b. The first side edge 101a is located on one side and the second side edge 101b is located on the opposite side of the first cage cup 101. The guide ring may have any suitable length and thickness, and may be made of for example stainless steel. The task of the guide ring 113 is to guide the rolling elements 305 in the bearing 300.

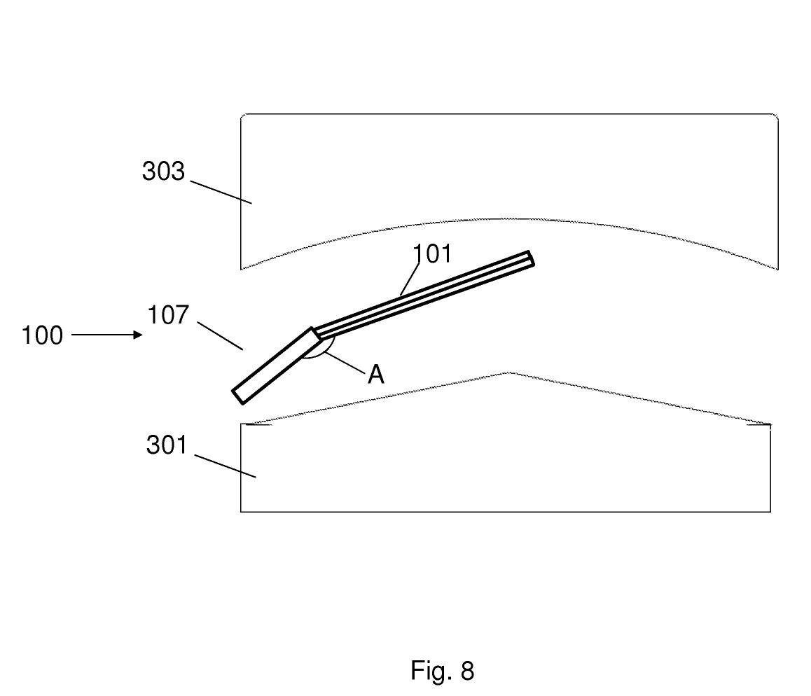

FIG. 8 illustrates an embodiment of the bearing component 100 where the first cage cup 101 is a laminated cage cup comprised of two thin elements laminated together. By laminating two thin elements, a thicker and stronger first cage cup 101 is obtained. Even though FIG. 8 shows two elements laminated together, the first cage cup 101 may comprise more than two elements laminated together, e.g. three, four or five elements laminated together. The number of elements laminated together depends on the function of the bearing component 100. The elements may be in the form of a strip or a string, formed as a ring.

The elements may be made of a polymer or a metal such as for example stainless steel, copper, brass or iron.

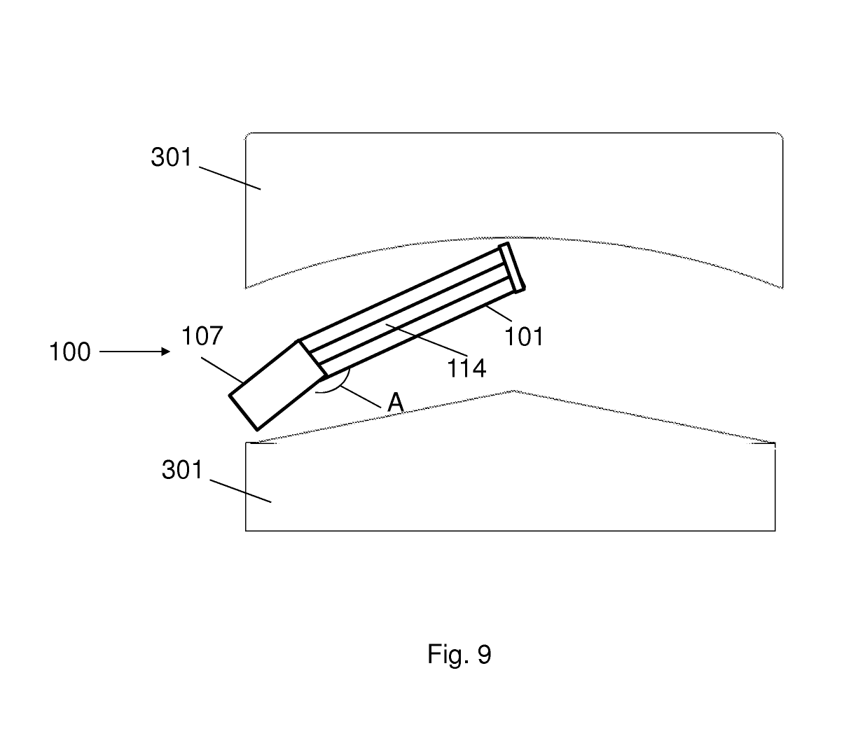

FIG. 9 illustrates an embodiment of the bearing component 100 wherein the first cage cup 101 is formed from at least two first elements. The at least two first elements are spaced apart with an air gap 114 between them. The at least two first elements are connected at a first end thereof and connected together at a second end thereof. The air gap 114 may function as a lubricant reservoir.

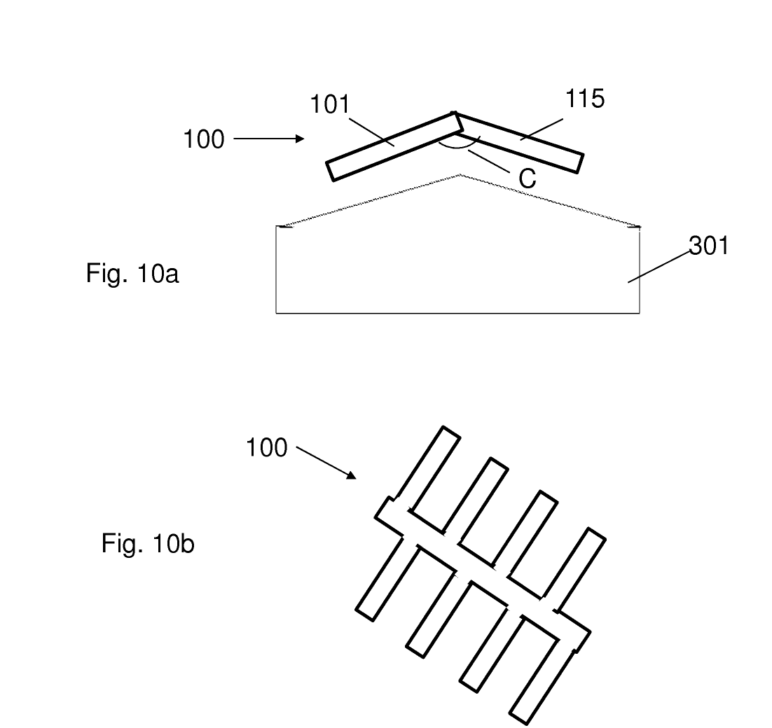

FIG. 10a illustrates an embodiment of the bearing component 100 comprising the first cage cup 101 and a second cage cup 115. The second cage cup 115 is formed from at least one fifth element and configured to receive the rolling elements 305. The fifth element may be in the form of a strip or a string, and it may be formed as a ring. The fifth element may be made of a polymer or a metal such as for example stainless steel, copper, brass or iron. The second cage cup 115 is connected to the first cage cup 101 with an angle C between them. The first cage cup 101 may be connected to the second cage cup 115 by means of for example a welding spot, a screw, a pin or a clip. The first flange 107 may be connected to the first cage cup 101 and the second flange 110 may be connected to the second cage cup 115. Thus, the second flange 110 may have different possible locations. In one embodiment, the second flange 110 is connected to the first cage cup 101, as exemplified in FIG. 6. In another embodiment, the second flange 110 is connected to the second cage cup 115, as exemplified in FIG. 10. FIG. 10b illustrates the first cage cup 101 connected to the second cage cup 115 seen from above.

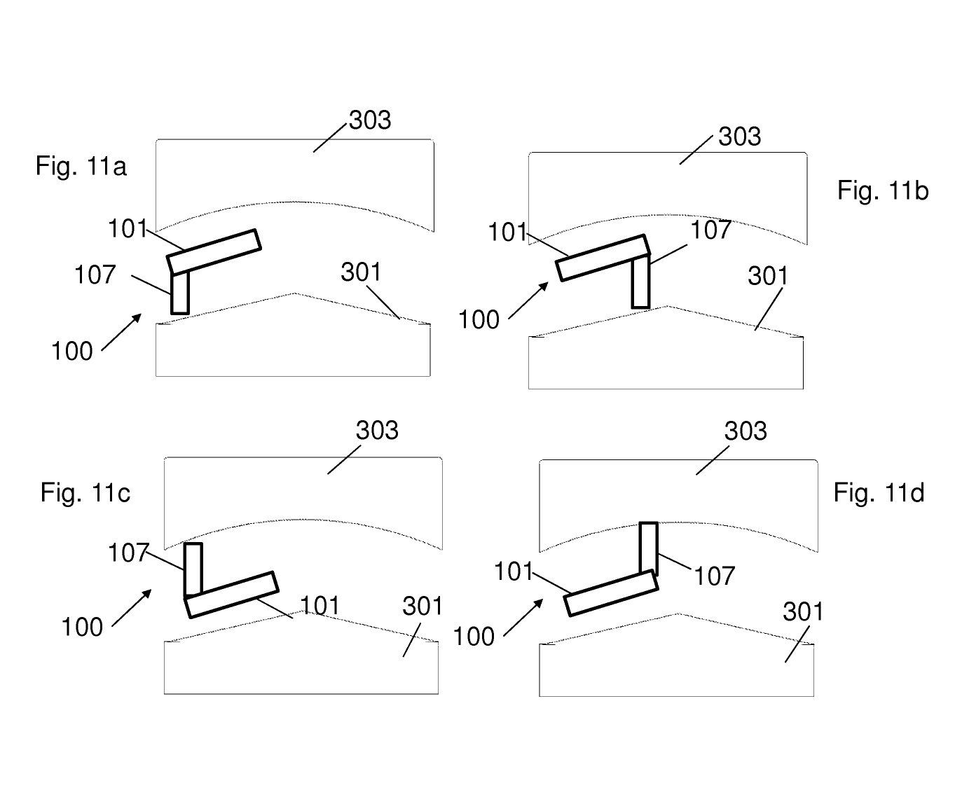

FIGS. 11a-d illustrates four different examples of how the bearing component 100 may be in connected with the inner ring 301 or the outer ring 303. In FIG. 11a, the first flange 107 is in contact with the inner ring 301, and at a point relatively close to the end of the inner ring 301. In FIG. 11b, the first flange 107 is contact with the inner ring 301 at a point in the middle of the inner ring 301. In FIG. 11c, the first flange 107 is contact with the outer ring 303 at a point relatively close to the end of the outer ring 303. In FIG. 11d, the first flange 107 is contact with the outer ring 303 at a point in the middle of the outer ring 303.

The first cage cup 101 and the second cage cup 115 may be a spherical roller bearing cage cup, a tapered roller bearing cage cup or a cylindrical roller bearing cage cup.

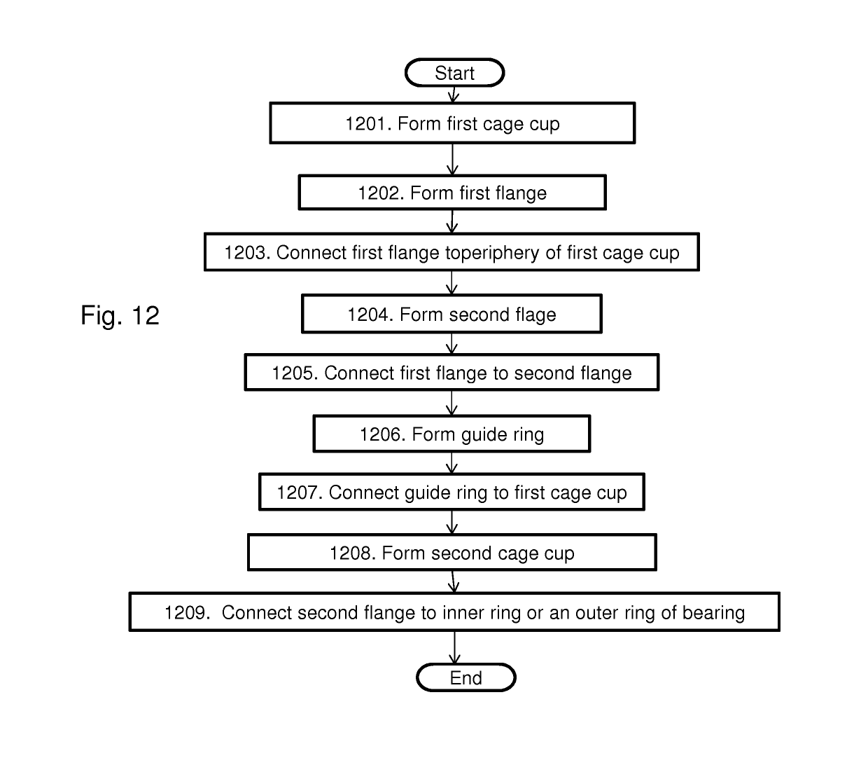

The method for manufacturing the bearing component will now be described with reference to the flow chart in FIG. 12. The method comprises the following steps, which steps may be performed in any suitable order:

Step 1201

The first cage cup 101 is formed from at least one first element configured to receive the rolling elements 305.

In some embodiments, the first cage cup 101 comprises a plurality of spaced pockets 105 configured to receive rolling elements 305. In some embodiments, the pockets 105 are milled pockets, punched pockets or drilled pockets.

In some embodiments, the outer diameter of the first cage cup 101 is equal to or greater than 0.5 m.

Step 1202

The first flange 107 is formed from at least one second element.

Step 1203

The first flange 107 is connected to the periphery of the first cage cup 101.

The first cage cup 101 may comprise a tapered surface and the first flange 107 is disk formed. The first flange 107 is connected to the first cage cup 101 so as to form the angle A between 0 Ë and 360 Ë between the plane of the first flange 107 and the tapered surface.

The first flange 107 may be connected to the first cage cup 101 by means of at least one of continuous welding, spot welding, screwing, gluing and clipping

In some embodiments, the first cage cup 101 is formed from at least two first metal strips. The at least two first elements are spaced apart and connected at a first end thereof and connected together at a second end thereof.

Step 1204

In some embodiment, the second flange 110 is formed from at least one third element.

Step 1205

In some embodiment, the second flange 110 is connected to the periphery of the first cage cup 101, and the first flange 107 is connected to the second flange 110 at the periphery of the first cage cup 101 so as to extend in different directions.

Step 1206

In some embodiments, the guide ring 113 is formed from at least one fourth element.

Step 1207

In some embodiments, the guide ring 113 is connected to one side edge, i.e. the second side edge 101b, of the periphery of the first cage cup 101. The first flange 107 is connected to the opposite side edge, i.e. the first side edge 101a.

Step 1208

In some embodiments, the second cage cup 115 is formed from at least one fifth element configured to receive the rolling elements 305. The first flange 107 is connected between the first cage cup 101 and the second cage cup 115.

In some embodiments, the second cage cup 115 comprises a plurality of spaced pockets 105 configured to receive the rolling elements.

In some embodiments, the first element, the second element, the third element, the fourth element and the fifth element have the same or different thickness.

In some embodiments, the first element, the second element, the third element, the fourth element, the fifth element are made of the same or different material. The material may be for example a metal or a polymer. In some embodiments, the first element is a first strip, the second element is a second strip, the third element is a third strip, the fourth element is a fourth strip and the fifth element is a fifth strip.

In some embodiments, the first cage cup 101 and the second cage cup 115 is a spherical roller bearing cage cup, a tapered roller bearing cage cup or a cylindrical roller bearing cage cup.

Step 1209

In some embodiments, at least one of the first flange 107 or the second flange 110 is in contact with at least one of the inner ring 301 and the outer ring 303 of the bearing 300.

The embodiments herein are not limited to the above described preferred embodiments. Various alternatives, modifications and equivalents may be used. Therefore, the above embodiments should not be taken as limiting the scope of the embodiments, which is defined by the appending claims.

It should be emphasized that the term “comprises/comprising” when used in this specification is taken to specify the presence of stated features, integers, steps or components, but does not preclude the presence or addition of one or more other features, integers, steps, components or groups thereof. It should also be noted that the words “a” or “an” preceding an element do not exclude the presence of a plurality of such elements.

It should also be emphasised that the steps of the methods defined in the appended claims may, without departing from the embodiments herein, be performed in another order than the order in which they appear in the claims.

1. A bearing component comprising:
a first cage cup formed from at least one first element configured to receive rolling elements; and
a first flange formed from at least one second element and connected to a periphery of the first cage cup.

2. The bearing component according to claim 1, further comprising:
a second flange formed from at least one third element and connected to the periphery of the first cage cup, wherein the first flange and the second flange are connected to the periphery of the first cage cup so as to extend in different directions.

3. The bearing component according to claim 1, further comprising:
a guide ring formed from at least one fourth element and connected to one side edge of the periphery of the first cage cup, wherein the first flange is connected to the opposite side edge.

4. The bearing component according to claim 1, further comprising:
a second cage cup formed from at least one fifth element and configured to receive the rolling elements, wherein the second cage cup is connected to the first cage cup.

5. The bearing component according to claim 1, wherein the first flange is connected to the first cage cup and the second flange is connected to the first cage cup by means of at least one of continuous welding, spot welding, screwing, gluing and clipping.

6. The bearing component according to claim 1, wherein the first cage cup is formed from at least two first elements, wherein the at least two first elements are spaced apart and connected at a first end thereof and connected together at a second end thereof.

7. The bearing component according to claim 4, wherein the first cage cup and the second cage cup each comprises a plurality of spaced pockets configured to receive rolling elements.

8. The bearing component according to claim 7, wherein the pockets are milled pockets, pressed pockets, laser cut pockets, punched pockets or drilled pockets.

9. The bearing component according to claim 1, wherein the first cage cup comprises a tapered surface and the first flange is disk formed, and wherein the first flange is connected to the first cage cup so as to form an angle between 0° and 360° between a plane of the first flange and said tapered surface.

10. The bearing component according to claim 2, wherein at least one of the first flange and the second flange are configured to be in contact with at least one of an inner ring and an outer ring of a bearing.

11. The bearing component according to claim 4, wherein the first element, the second element, the third element, the fourth element and the fifth element have a same or different thickness.

12. The bearing component according to claim 4, wherein the first element, the second element, the third element, the fourth element and the fifth element are made of the same or different material, wherein the material is a metal or a polymer.

13. The bearing component according to claim 4, wherein the first element is a first strip, the second element is a second strip, the third element is a third strip, the fourth element is a fourth strip and the fifth element is a fifth strip.

14. The bearing component according to claim 4, wherein an outer diameter of the first cage cup is equal to or greater than 0.5 m.

15. The bearing component according to claim 4, wherein the first cage cup and the second cage cup each are a spherical roller bearing cage cup, a tapered roller bearing cage cup or a cylindrical roller bearing cage cup.

16. The bearing component according to claim 1, wherein the bearing component is assembled into a bearing.

17. A method for manufacturing a bearing component, the method comprising:
forming a first cage cup from at least one first element configured to receive rolling elements;
forming a first flange from at least one second element; and
connecting the first flange to a periphery of the first cage cup.

18. The method according to claim 17, further comprising:
forming a second flange from at least one third element; and connecting the second flange to the periphery of the first cage cup,
wherein the first flange and the second flange are connected to the periphery of the first cage cup so as to extend in different directions.

19. The method according to claim 17, further comprising:
forming a guide ring from at least one fourth element; and
connecting the guide ring to one side edge of the periphery of the first cage cup, wherein the first flange is connected to the opposite side edge.

20. The method according to claim 17, further comprising:
forming a second cage cup from at least one fifth element and configured to receive the rolling elements, wherein second cage cup is connected to the first cage cup.

21. The method according to claim 18, wherein the first flange is connected to the first cage cup and the second flange is connected to the first cage cup by means of at least one of continuous welding, spot welding, screwing, gluing and clipping.

22. The bearing method according to claim 17, wherein the first cage cup is formed from at least two first elements, wherein the at least two first elements are spaced apart and connected at a first end thereof and connected together at a second end thereof.

23. The method according to claim 20, wherein the first cage cup and the second cage cup each comprises a plurality of spaced pockets configured to receive rolling elements.

24. The method according to claim 23, wherein the pockets are milled pockets, pressed pockets, laser cut pockets, punched pockets or drilled pockets.

25. The method according to claim 17, wherein the first cage cup comprises a tapered surface and the first flange is disk formed, and wherein the first flange is connected to the first cage cup so as to form an angle between 0° and 360° between a plane of the first flange and said tapered surface.

26. The method according to claim 18, wherein at least one of the first flange and the second flange are configured to be in contact with at least one of an inner ring and an outer ring of a bearing.

27. The method according to claim 20, wherein the first element, the second element, the third element, the fourth element and the fifth element have a same or different thickness.

28. The method according to claim 20, wherein the first element, the second element, the third element, the fourth element and the fifth element are made of the same or different material, wherein the material is a metal or a polymer.

29. The method according to claim 20, wherein the first element is a first strip, the second element is a second strip, the third element is a third strip, the fourth element is a fourth strip and the fifth element is a fifth strip.

30. The method according to claim 17, wherein an outer diameter of the first cage cup is equal to or greater than 0.5 m.

31. The method according to claim 20, wherein the first cage cup and the second cage cup each are a spherical roller bearing cage cup, a tapered roller bearing cage cup or a cylindrical roller bearing cage cup.
